(19) United States
(12) Patent Application Publication
(10) Pub. No.: US 2018/0336608 A1
(43) Pub. Date: Nov. 22, 2018

(54) SYSTEM AND METHOD FOR PROMOTING PRODUCT SALES BY USING DISTRIBUTION OF SALES PROFIT ACCORDING TO EVENT SUCCESS

(71) Applicant: SV INC., Seoul (KR)

(72) Inventors: Yong Hyun KANG, Suwon-si (KR); Du Hyun Kim, Seoul (KR)

(21) Appl. No.: 16/050,037

(22) Filed: Jul. 31, 2018

Related U.S. Application Data
(63) Continuation of application No. PCT/KR2017/000760, filed on Jan. 23, 2017.

(30) Foreign Application Priority Data
Feb. 6, 2016 (KR) 10-2016-0015339
Apr. 16, 2016 (KR) 10-2016-0046620

(51) Int. Cl. G06Q 30/06; G06Q 20/08

(52) U.S. Cl. CPC G06Q 30/0601; G06Q 20/08

(57) ABSTRACT

A product sales promotion system comprises an event configuration unit receiving sales price of a product, a target period of time for product sales, a target amount of product sales, and a basic profit from a seller, setting an event which is decided to be successful when the target amount of product sales is reached within the target period of time, and receiving an amount of an additional profit to be distributed to the purchaser when the event is successful, an additional distribution way, and an additional distribution rate from the seller; a product payment unit receiving a payment for the product from the purchaser; an event management unit activating the event and checking whether the number of payments reaches the target; and a profit distribution unit paying the basic profit to the purchaser and, when the event is successful, paying the additional profit to the purchasers.

### CROSS-REFERENCE TO RELATED APPLICATION

The present application is a continuation-in-part of PCT Application No. PCT/KR2017/000760, filed on Jan. 23, 2017, which claims priority of Korean Patent Application No. 10-2016-0015339 filed on Feb. 6, 2016 and Korean Patent Application No. 10-2016-0046620 filed on Apr. 16, 2016. The contents of these applications are incorporated herein by reference in their entirety.

### BACKGROUND

### (a) Technical Field

An aspect of the disclosed technology relates to an E-commerce system and method using a financial technology. Particularly, an aspect of the disclosed technology relates to a product sales promotion system and method using distribution of sales profit according to event success.

### (b) Description of the Related Art

E-commerce is the activity of buying or selling of products on online services or over the Internet. Recently, the E-commerce becomes to prevail the conventional off-line commerce, and therefore the technology advancing the E-commerce becomes more and more important.

A consumption behavior in a conventional economic system is carried out by paying for a product in cash and thus obtaining the product. Under such a structure, if large consumption is made, the cash assets of a consumer are just reduced, so that the consumer has to cut down his or her consumption so as to increase or maintain his or her cash assets.

If an economic depression occurs, accordingly, the consumer lowers his or her consumption, and thus, product sales are reduced. Subsequently, product sellers reduce the number of workers or their wage due to the decrement of their sales, and therefore, the consumer's income becomes reduced, so that he or she reduces the consumption more and more, thereby making such a vicious circle to be repeated under such a structure.

If the cash assets of the consumer are increased in related to his or her consumption, the phenomena will be reversed. In detail, the consumer increases his or her consumption more, and accordingly, product sales are drastically increased. Also, the product sellers increase the number of workers or their wage through the drastic increment of their sales and, in turns, the consumer's increased income promotes his or her consumption, so that if such an economic system is achieved, the world economy will be in the boom years.

Therefore, it will be a significant advance in the E-commerce if a new promoting technology providing a financial system wherein the cash assets of the consumer are increased in accordance with his or her consumption.

### SUMMARY

Various embodiments are provided to introduce a unique manner of product sales promotion system and method that distributes a portion of sales profit to purchasers under the condition that a product selling event defined by a seller is successful to increase the cash assets of the purchasers, so that the product sales are promoted.

The aspect of the product sales promotion system and method disclosed herein is not limited to the content as mentioned above, and other aspects not mentioned herein could be understood by the ordinary person in the art from the description below.

A product sales promotion system according to an embodiment of the disclosed technology may include: an event configuration unit adapted to receive at least one of sales price of a product, a target period of time for product sales, a target amount of product sales, and a basic profit to be distributed to a purchaser from a terminal of a seller, to set an event which is decided to be successful when the target amount of product sales is reached within the target period of time according to an input from the terminal of the seller, and to receive at least one of an amount of an additional profit to be distributed to the purchaser when the event is successful, an additional distribution way of the additional profit, and an additional distribution rate of the additional profit from the terminal of the seller; a product payment unit adapted to receive a payment for the product from a terminal of the purchaser; an event management unit adapted to activate the event and to check whether the number of payments for the product received by the product payment unit reaches the target amount of product sales; and a profit distribution unit adapted to pay the basic profit to the purchaser and, when the event management unit decides that the event is successful, to pay the additional profit to the purchaser.

Before the event is activated, the event management unit may transmit an event notification message for notifying a start date and a start time of the event activation to a terminal of a member joined in the product sales promotion system.

The event management unit may activate the event after a predetermined standby period from a start time of the event activation.

The event configuration unit may receive a guaranteed amount lower than the sales price of the product from the terminal of the seller, and the payment received by the event management unit is the payment for the guaranteed amount or for the sales price.

The product sales promotion system may further include: a system account unit adapted to deposit an amount given by the payment; and a member account unit allocated to the member joined in the product sales promotion system, the member account unit adapted to deposit at least one of cyber money and cash.

Before or at the same time as the event activation starts, an event deposit of the seller which is the same amount as the additional profit is transferred from the member account unit of the seller to the system account unit.

The event management unit may transmit a sales price additional payment request to a terminal of a purchaser who made a payment only for the guaranteed amount (hereinafter, referred to as a “guaranteed amount payment purchaser”), and when the guaranteed amount payment purchaser makes a sales price additional payment through the terminal of the guaranteed amount payment purchaser to the product payment unit, the event management unit transfers an amount corresponding to the guaranteed amount from an amount deposited in the system account unit to the member account unit of a guaranteed amount payment purchaser who makes the sales price additional payment (hereinafter, referred to as a “sales price additional payment purchaser”).

The product sales promotion system may further include a delivery management unit adapted to transmit a delivery address of a purchaser who makes a payment for the sales price without a payment for the guaranteed amount (hereinafter, referred to as a “sales price payment purchaser”) and/or a delivery address of the sales price additional payment purchaser to the terminal of the seller.

The product sales promotion system may further include a purchase confirmation management unit adapted to transmit a purchase confirmation request to the terminal of the sales price payment purchaser and/or the terminal of the sales price additional payment purchaser, and to receive a response to the purchase confirmation request from the terminal of the sales price payment purchaser and/or the terminal of the sales price additional payment purchaser, wherein when the response to the purchase confirmation request is a purchase confirmation response, the profit distribution unit transfers the basic profit from the system account unit to the member account units of the sales price payment purchaser and/or the sales price additional payment purchaser, and wherein when the response to the purchase confirmation request is a purchase cancel response, the profit distribution unit transfers an amount corresponding to the sales price to the member account units of the sales price payment purchaser and/or the sales price additional payment purchaser, but when the event management unit decides that the event is successful, the profit distribution unit transfers an amount calculated by subtracting an amount corresponding to the guaranteed amount from the amount corresponding to the sales price to the member account units of the sales price payment purchaser and/or the sales price additional payment purchaser.

The product sales promotion system may further include a purchase confirmation management unit adapted to transmit a purchase confirmation request to the terminal of the sales price payment purchaser and/or the terminal of the sales price additional payment purchaser, and to receive a response to the purchase confirmation request from the terminal of the sales price payment purchaser and/or the terminal of the sales price additional payment purchaser, wherein when the response to the purchase confirmation request is a purchase confirmation response, the profit distribution unit transfers the basic profit from the system account unit to the member account units of the sales price payment purchaser and/or the sales price additional payment purchaser, and wherein when the response to the purchase confirmation request is a purchase cancel response, the profit distribution unit transfers an amount calculated by subtracting an amount corresponding to the guaranteed amount from the sales price to the member account units of the sales price payment purchaser and/or the sales price additional payment purchaser, and when the event management unit decides that the event fails, the profit distribution unit transfers an amount corresponding to the guaranteed amount to the member account units of the sales price payment purchaser and/or the sales price additional payment purchaser.

When the event management unit decides that the event is successful, the profit distribution unit may determine individual additional profits to be distributed to the sales price payment purchaser and/or the sales price additional payment purchaser who transmitted the purchase confirmation response (hereinafter, referred to as “purchase confirmation purchasers”) by applying the additional distribution way and the additional distribution rate of the additional profit, and the profit distribution unit transfers the individual additional profits from an amount kept in the system account unit to the member account units of the purchase confirmation purchasers.

The product sales promotion system may further include a minimum guaranteed amount calculation unit adapted to notify the terminal of the seller of a minimum guaranteed amount, when the event configuration unit receives the guaranteed amount from the terminal of the seller, wherein the minimum guaranteed amount is calculated by dividing a largest individual additional profit among the individual additional profits which are calculated when the event is successful by the target amount of product sales.

The product sales promotion system may further include a minimum guaranteed amount calculation unit adapted to notify the terminal of the seller of a minimum guaranteed amount, when the event configuration unit receives the guaranteed amount from the terminal of the seller, wherein the minimum guaranteed amount is calculated by dividing the event deposit by the target amount of product sales.

The additional distribution way may include arranging the purchase confirmation purchasers in an order of payment; paying a first individual additional profit calculated by multiplying the additional profit by the additional distribution rate of the additional profit to a first purchase confirmation purchaser who performs an earliest payment among the purchase confirmation purchasers; and paying a second individual additional profit calculated by multiplying an amount remained after subtracting the first individual additional profit from the additional profit by the additional distribution rate of the additional profit to a second purchase confirmation purchaser who performs a payment in the second earliest among the purchase confirmation purchasers.

The member account unit may include a cyber money account in which cyber money is deposited, and the additional distribution way may include arranging the purchase confirmation purchasers in an order of cyber money amount of the cyber money account of the purchase confirmation purchaser; paying a first individual additional profit calculated by multiplying the additional profit by the additional distribution rate of the additional profit to a first purchase confirmation purchaser who has a largest cyber money amount among the purchase confirmation purchasers; and paying a second individual additional profit calculated by multiplying an amount remained after subtracting the first individual additional profit from the additional profit by the additional distribution rate of the additional profit to a second purchase confirmation purchaser who has a second largest cyber money amount among the purchase confirmation purchasers.

The member account unit may include a cyber money account in which cyber money is deposited, and the additional distribution way may include arranging the purchase confirmation purchasers in an order of a value calculated by multiplying the cyber money amount of the cyber money account of the purchase confirmation purchaser by the number of payments of the purchase confirmation purchaser (hereinafter, referred to as a “multiplied value for order”); paying a first individual additional profit calculated by multiplying the additional profit by the additional distribution rate of the additional profit to a first purchase confirmation purchaser who has a largest multiplied value for order among the purchase confirmation purchasers; and paying a second individual additional profit calculated by multiplying an amount remained after subtracting the first individual additional profit from the additional profit by the additional distribution rate of the additional profit to a second purchase confirmation purchaser who has a second largest multiplied value for order among the purchase confirmation purchasers.

The additional distribution way may include arranging the purchase confirmation purchasers in an order of sales price payment; paying a first individual additional profit calculated by multiplying the additional profit by the additional distribution rate of the additional profit to a first purchase confirmation purchaser who performs an earliest sales price payment among the purchase confirmation purchasers; and paying a second individual additional profit calculated by multiplying an amount remained after subtracting the first individual additional profit from the additional profit by the additional distribution rate of the additional profit to a second purchase confirmation purchaser who performs a sales price payment in the second earliest among the purchase confirmation purchasers.

The additional distribution way may include arranging the purchase confirmation purchasers in an order of purchase confirmation response; paying a first individual additional profit calculated by multiplying the additional profit and the additional distribution rate of the additional profit to a first purchase confirmation purchaser who performs an earliest purchase confirmation response among the purchase confirmation purchasers; and paying a second individual additional profit calculated by multiplying the amount remained after subtracting the first individual additional profit from the additional profit by the additional distribution rate of the additional profit to a second purchase confirmation purchaser who performs a purchase confirmation response in the second earliest among the purchase confirmation purchasers.

When the payment is performed, the profit distribution unit may transmit an expected additional distribution order in which the purchasers who perform the payment are arranged in order according to the additional distribution way to the terminals of the purchasers who perform the payment.

The expected additional distribution order may be made by arranging the purchasers who perform the payment in an order of the payment.

The expected additional distribution order may be made by arranging the purchasers who perform the payment in an order of a value obtained by multiplying the cyber money amount deposited in the cyber money account included in the member account unit of the purchaser who performs the payments by the number of the payments.

The expected additional distribution order may be made by arranging the purchasers who perform the payment in an order of the sales price payment.

The expected additional distribution order may be made by arranging the purchasers who perform the payment in an order of the purchase confirmation response of the purchasers who perform the payment with respect to the purchase confirmation request transmitted from the purchase confirmation management unit to the terminals of the purchasers who perform the payment.

A product sales promotion method according to an embodiment of the disclosed technology may include the steps of: (a) inputting at least one of sales price of a product, a target period of time for product sales, a target amount of product sales, and a basic profit to be distributed to a purchaser to an event configuration unit through a terminal of a seller; (b) setting an event which is decided to be successful when the target amount of product sales is reached within the target period of time on the event configuration unit through the terminal of the seller, and inputting at least one of an amount of an additional profit to be distributed to the purchaser when the event is successful, an additional distribution way of the additional profit, and an additional distribution rate of the additional profit to the event configuration unit through the terminal of the seller; (c) activating the event through an event management unit; (d) performing a payment for the product by a terminal of the purchaser through a product payment unit; (e) checking whether the number of payments for the product received by the product payment unit reaches the target amount of product sales, through the event management unit; (f) paying the basic profit to the purchaser through a profit distribution unit; and (g) when the event management unit decides that the event is successful, paying the additional profit to the purchaser through the profit distribution unit.

The product sales promotion method may further include, before the step (c), the step of transmitting an event notification message for notifying a start date and a start time of the event activation to the terminal of the member joined in the product sales promotion system, through the event management unit.

The step (c) may include the step of activating the event after a predetermined standby period from a start time of the event activation, through the event management unit.

The product sales promotion method may further include, before the step (c), the step of receiving a guaranteed amount lower than the sales price of the product from the terminal of the seller, through the event configuration unit, and the payment received by the event management unit is the payment for the guaranteed amount or for the sales price. The product sales promotion method may further include, before or at the same time as the step (c), the step of transferring an event deposit of the seller which is the same amount as the additional profit from the member account unit of the seller to a system account unit.

The product sales promotion method may further include, after the step (d), the step of depositing an amount made by the payment into the system account unit.

The step (d) may include the steps of: making a payment for the guaranteed amount of the product to the product payment unit through the terminal of the purchaser; transmitting a sales price additional payment request to a terminal of a guaranteed amount payment purchaser, through the event management unit; making a sales price additional payment to the product payment unit through the terminal of the guaranteed amount payment purchaser; and transferring an amount corresponding to the guaranteed amount from an amount deposited in the system account unit to the member account unit of a sales price additional payment purchaser.

The product sales promotion method may further include, after the step (d), the step of transmitting a delivery address of a sales price payment purchaser and/or a delivery address of the sales price additional payment purchaser to the terminal of the seller, through a delivery management unit.

The step (f) may include the steps of: transmitting a purchase confirmation request to the terminals of the sales price payment purchaser and/or the terminal of the sales price additional payment purchaser, through a purchase confirmation management unit; receiving a response to the purchase confirmation request from the terminal of the sales price payment purchaser and/or the terminal of the sales price additional payment purchaser; and when the response to the purchase confirmation request is a purchase confirmation response, transferring the basic profit from the system account unit to the member account units of the sales price payment purchaser and/or the sales price additional payment purchaser, through the profit distribution unit, and when the response to the purchase confirmation request is a purchase cancel response, transferring an amount corresponding to the sales price to the member account units of the sales price payment purchaser and/or the sales price additional payment purchaser, through the profit distribution unit, but when the event management unit decides that the event is successful, transferring an amount calculated by subtracting an amount corresponding to the guaranteed amount from the amount corresponding to the sales price to the member account units of the sales price payment purchaser and/or the sales price additional payment purchaser, through the profit distribution unit.

The step (f) may include the steps of: transmitting a purchase confirmation request to the terminal of the sales price payment purchaser and/or the terminal of the sales price additional payment purchaser, through a purchase confirmation management unit;

receiving a response to the purchase confirmation request from the terminal of the sales price payment purchaser and/or the terminal of the sales price additional payment purchaser, through the purchase confirmation management unit; and when the response to the purchase confirmation request is a purchase confirmation response, transferring the basic profit from the system account unit to the member account units of the sales price payment purchaser and/or the sales price additional payment purchaser, through the profit distribution unit, and when the response to the purchase confirmation request is a purchase cancel response, transferring an amount calculated by subtracting an amount corresponding to the guaranteed amount from the sales price to the member account units of the sales price payment purchaser and/or the sales price additional payment purchaser, through the profit distribution unit, and when the event management unit decides that the event fails, transferring an amount corresponding to the guaranteed amount to the member account units of the sales price payment purchaser and/or the sales price additional payment purchaser, through the profit distribution unit.

The step (g) may include the steps of: when the event management unit decides that the event is successful, determining individual additional profits to be distributed to purchase confirmation purchasers by applying the additional distribution way and the additional distribution rate of the additional profit, through the profit distribution unit; and transferring the individual additional profits from an amount kept in the system account unit to the member account units of the purchase confirmation purchasers, through the profit distribution unit.

The product sales promotion method may further include the step of notifying the terminal of the seller of a minimum guaranteed amount, through a minimum guaranteed amount calculation unit, before the step of receiving the guaranteed amount lower than the sales price from the terminal of the seller through the event configuration unit, wherein the minimum guaranteed amount is calculated by dividing a largest individual additional profit among the individual additional profits calculated when the event is successful by the target amount of product sales.

The product sales promotion method may further include the step of notifying the terminal of the seller of a minimum guaranteed amount, through a minimum guaranteed amount calculation unit, before the step of receiving the guaranteed amount lower than the sales price from the terminal of the seller through the event configuration unit, wherein the minimum guaranteed amount is calculated by dividing the event deposit by the target amount of product sales.

The additional distribution way may include arranging the purchase confirmation purchasers in an order of payment; paying a first individual additional profit calculated by multiplying the additional profit by the additional distribution rate of the additional profit to a first purchase confirmation purchaser who performs an earliest payment among the purchase confirmation purchasers; and paying a second individual additional profit calculated by multiplying an amount remained after subtracting the first individual additional profit from the additional profit by the additional distribution rate of the additional profit to a second purchase confirmation purchaser who performs a payment in the second earliest among the purchase confirmation purchasers.

The additional distribution way may include arranging the purchase confirmation purchasers in an order of cyber money amount of the purchase confirmation purchaser; paying a first individual additional profit calculated by multiplying the additional profit by the additional distribution rate of the additional profit to a first purchase confirmation purchaser who has a largest cyber money amount among the purchase confirmation purchasers; and paying a second individual additional profit calculated by multiplying an amount remained after subtracting the first individual additional profit from the additional profit by the additional distribution rate of the additional profit to a second purchase confirmation purchaser who has a second largest cyber money amount among the purchase confirmation purchasers.

The additional distribution way may include arranging the purchase confirmation purchasers in an order of multiplied value for order of the purchase confirmation purchaser; paying a first individual additional profit calculated by multiplying the additional profit by the additional distribution rate of the additional profit to a first purchase confirmation purchaser who has a largest multiplied value for order among the purchase confirmation purchasers; and paying a second individual additional profit calculated by multiplying an amount remained after subtracting the first individual additional profit from the additional profit by the additional distribution rate of the additional profit to a second purchase confirmation purchaser who has a second largest multiplied value for order among the purchase confirmation purchasers.

The additional distribution way may include arranging the purchase confirmation purchasers in an order of sales price payment; paying a first individual additional profit calculated by multiplying the additional profit by the additional distribution rate of the additional profit to a first purchase confirmation purchaser who performs an earliest sales price payment among the purchase confirmation purchasers; and paying a second individual additional profit calculated by multiplying an amount remained after subtracting the first individual additional profit from the additional profit by the additional distribution rate of the additional profit to a second purchase confirmation purchaser who performs a sales price payment in the second earliest among the purchase confirmation purchasers.

The additional distribution way may include arranging the purchase confirmation purchasers in an order of purchase confirmation response; paying a first individual additional profit calculated by multiplying the additional profit and the additional distribution rate of the additional profit to a first purchase confirmation purchaser who performs an earliest purchase confirmation response among the purchase confirmation purchasers; and paying a second individual additional profit calculated by multiplying the amount remained after subtracting the first individual additional profit from the additional profit by the additional distribution rate of the additional profit to a second purchase confirmation purchaser who performs a purchase confirmation response in the second earliest among the purchase confirmation purchasers.

The step (d) may include the step of transmitting an expected additional distribution order in which the purchasers who perform the payment are arranged in order according to the additional distribution way to the terminals of the purchasers who perform the payment, through the profit distribution unit, when the payment is performed.

The expected additional distribution order may be made by arranging the purchasers who perform the payment in an order of the payment.

The expected additional distribution order may be made by arranging the purchasers who perform the payment in an order of a value obtained by multiplying the cyber money amount deposited in the cyber money account included in the member account unit of the purchaser who performs the payments by the number of the payments.

The expected additional distribution order may be made by arranging the purchasers who perform the payment in an order of the sales price payment.

The expected additional distribution order may be made by arranging the purchasers who perform the payment in an order of the purchase confirmation response of the purchasers who perform the payment with respect to the purchase confirmation request transmitted from the purchase confirmation management unit to the terminals of the purchasers who perform the payment.

According to the embodiments of the disclosed technology, the product sales are promoted by distributing a portion of sales profit to the purchasers under a condition that the product selling event defined by the seller is successful.

According to the embodiments of the disclosed technology, because the event is succeeded merely with the payment of the guaranteed amount, it is possible to make the event success in a short time, thereby the additional profit distribution to the purchasers being accelerated,

According to the embodiments of the disclosed technology, the event success is made even with the payment of the guaranteed amount, and the purchaser can see the amount of the additional profit to be distributed, thereby encouraged to pay the remaining sales price.

According to the embodiments of the disclosed technology, because confirmation of purchase is demanded before distributing the additional profit, refund after distributing the additional profit is prevented.

According to the embodiments of the disclosed technology, if the purchase is canceled despite the success of the event, the amount subtracting the guaranteed amount is refunded and the guaranteed amount from the purchasers who have canceled the purchase is added to the total amount of the additional profit, thereby preventing the loss of the seller. According to the embodiments of the disclosed technology, when the purchase is canceled after the success of the event, the guaranteed amount is not refunded, thereby the purchaser being discouraged from canceling the purchase.

As discussed above, the disclosed technology provides a significant improvement in promoting product sales.

### BRIEF DESCRIPTION OF THE DRAWINGS

FIG. 1 is an exemplary block diagram showing a configuration of a product sales promotion system according to an embodiment of the disclosed technology.

FIG. 2 is an exemplary flowchart showing processes of selling products and distributing sales profit in the product sales promotion system according to an embodiment of the disclosed technology, wherein a purchaser makes a payment for the guaranteed amount on an event configured by a seller and performs a purchase confirmation response.

FIG. 3 is an exemplary flowchart showing processes of selling products and distributing sales profit in the product sales promotion system according to an embodiment of the disclosed technology, wherein a purchase confirmation management unit at step S230 of FIG. 2 receives a purchase cancel response from a sales price additional payment purchaser.

FIG. 4 is an exemplary flowchart showing processes of selling products and distributing sales profit in the product sales promotion system according to an embodiment of the disclosed technology, wherein the purchaser makes a payment for the sales price on the event configured by the seller and performs the purchase confirmation response.

FIG. 5 is an exemplary flowchart showing processes of selling products and distributing sales profit in the product sales promotion system according to an embodiment of the disclosed technology, wherein the purchase confirmation management unit at step S500 of FIG. 4 receives the purchase cancel response from the purchaser who makes a payment for the sales price.

### DETAILED DESCRIPTION

Hereinafter, a product sales promotion system and method according to an embodiment will now be described in detail with reference to the attached drawings. The embodiment is only an example of the invention. The features included in the embodiment are not necessarily essential to a solution of the invention. In describing the embodiment, an explanation of a well-known technology in the related art will be omitted for the brevity of the description.

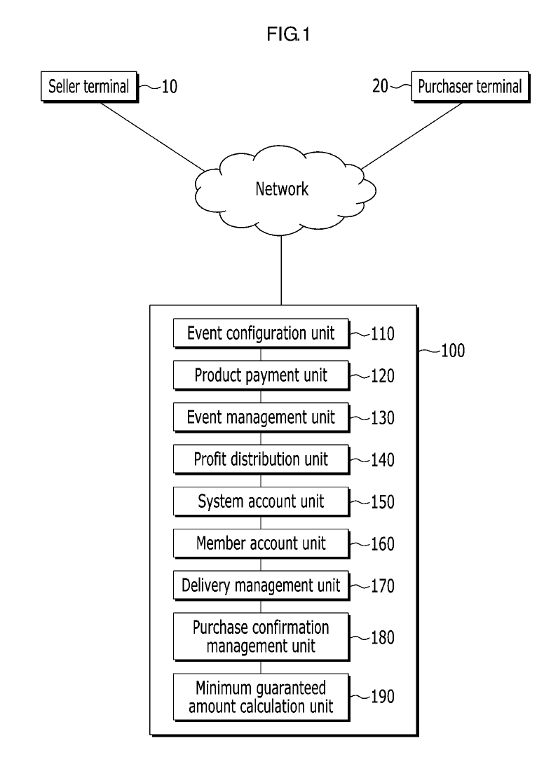

FIG. 1 is a schematic block diagram showing a configuration of a product sales promotion system according to an embodiment of the disclosed technology.

A product sales promotion system 100 according to an embodiment of the disclosed technology may include an event configuration unit 110, a product payment unit 120, an event management unit 130, a profit distribution unit 140, a system account unit 150, a member account unit 160, a delivery management unit 170, a purchase confirmation management unit 180, and a minimum guaranteed amount calculation unit 190.

The product sales promotion system 100 may be implemented with a microprocessor or a central processing unit (CPU), a storage device such as a volatile memory and/or a non-volatile memory, a communication device such as a modem, a network card, a Wi-Fi device, an infrared device, or a Bluetooth device, and peripheral devices. The respective units 110, 120, 130, 140, 150, 160, 170, 180, and 190 of the product sales promotion system 100 may be implemented by one or more software installed in the storage device and operated by the microprocessor or a central processing unit (CPU). The respective units 110, 120, 130, 140, 150, 160, 170, 180, and 190 of the product sales promotion system 100 may be implemented by one or more hardware respectively having a microprocessor or a central processing unit (CPU) and a storage device in which a software is installed. The product sales promotion system 100 may be implemented in one computer or a server, or may be implemented by a plurality of computers or servers distributed and linked to a communication network to provide communication between the distributed computers or servers.

The network provides data communication between the product sales promotion system 100 and the seller terminal 10 and the purchaser terminal 20. The network may be embodied in various types such as Internet, Local Area Network (LAN), Metropolitan Area Network (MAN), Wide Area Network (WAN) and etc.

A seller may be connected to the product sales promotion system 100 by using a seller terminal 10 through wired and/or wireless network. A purchaser may be connected to the product sales promotion system 100 by using a purchaser terminal 20 through the wired and/or wireless network. The seller terminal 10 and the purchaser terminal 20 may be devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above.

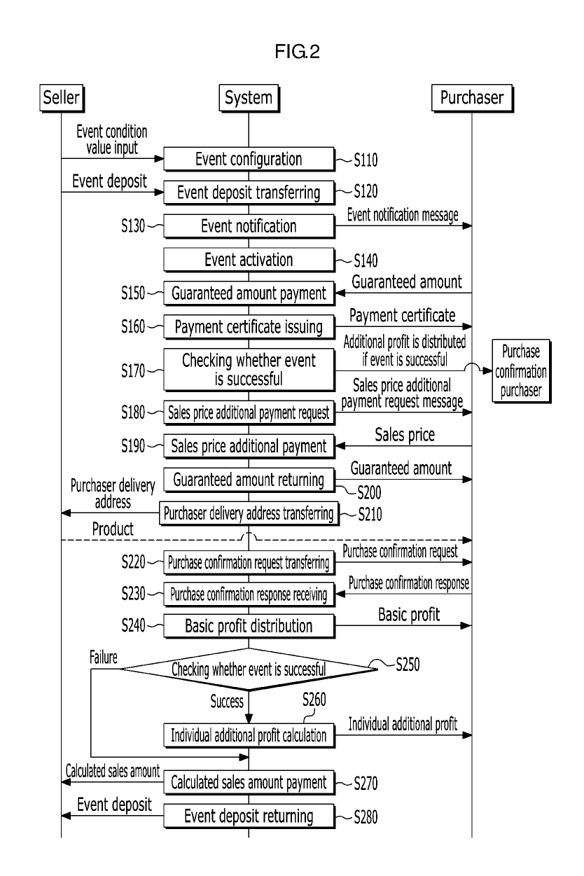

The seller and the purchaser may be members who join the product sales promotion system 100, and the members of the product sales promotion system 100 may have cyber money accounts and/or cash accounts connected to their own accounts. The cyber money accounts and/or the cash accounts may be included in the member account unit 160. The cyber money deposited in the cyber money accounts may be used as a distribution standard when an additional profit as will be discussed later is distributed, and the basic profit and the additional profit are put into the cyber money accounts in the form of cyber money. The cash in the cash accounts may be transferred to the cyber money accounts, exchanged with the cyber money in the ratio of 1:1 or in a predetermined ratio, and deposited in the cyber money accounts. Contrarily, the cyber money in the cyber money accounts may be transferred to the cash accounts, but in this case, desirably, a withdrawal fee at a given percentage for the transferring money has to be paid. The withdrawal fee may be transferred to the system account unit 150 of the product sales promotion system 100, and the cash may be transferred to the cash accounts of the members. The cyber money may be referred to as different names, for example, reward points, mileages, coupons, credits, gifts, incentives, energy currency, etc. FIG. 2 is an exemplary flowchart showing the processes of selling products and distributing sales profit in the product sales promotion system according to an embodiment of the disclosed technology, wherein the purchaser makes a payment for the guaranteed amount on an event configured by the seller and performs a purchase confirmation response.

The seller is connected to the product sales promotion system 100 by using the seller terminal 10, and he or she selects an event configuration menu so as to set an event to be successful when a target amount of product sales is reached within a target period of time for product sales. The event configuration unit 110 displays, on the seller terminal 10, an input screen where, as event condition values, the sales price of a product, the target period of time for product sales, the target amount of product sales, a basic profit, a guaranteed amount, an additional profit to be distributed to the purchasers performing purchase confirmation responses if the event is successful, an additional distribution way of the additional profit, and an additional distribution rate of the additional profit are inputted, and the seller inputs, on the seller's terminal 10, the sales price of the product to be sold through the product sales promotion system 100, the target period of time for product sales, the target amount of product sales, the basic profit, the guaranteed amount, the additional profit, the additional distribution way of the additional profit, and the additional distribution rate of the additional profit. The values inputted to the event configuration unit 110 through the seller terminal 10 are stored in the event configuration unit 110, thereby completing setting the event (at step S110).

The basic profit is an amount corresponding to a portion of the sales price that is distributed to the purchasers performing purchase confirmation responses, irrespective of the event success. The guaranteed amount may be set lower than the sales price, and the purchaser who wants to purchase the product may make a payment for the total sales price of the product or for the guaranteed amount. If the payment for the sales price of the product or for the guaranteed amount is made, a payment certificate is issued by the event management unit 130, and if the number of payment certificates reaches the target amount of product sales, it is considered that the event is successful. That is, the purchaser may make a payment for the total sales price of the product or only for the guaranteed amount so as to join the event.

The sales price of the product, the target period of time of product sales, the target amount of product sales, the basic profit, the guaranteed amount, the additional profit, the additional distribution way of the additional profit, and the additional distribution rate of the additional profit may be arbitrarily determined by the seller, and some of them may be suggested with appropriate values by means of the product sales promotion system 100. Further, some of them may be in advance calculated as optimized values by means of the product sales promotion system 100 and provided as fixed values.

The minimum guaranteed amount calculation unit 190 may calculate a minimum guaranteed amount, and the calculated minimum guaranteed amount may be transmitted to the seller terminal 10.

The minimum guaranteed amount is desirably determined by dividing the largest amount among individual additional profits calculated when the event is successful by the target amount of product sales. In case where the event is set to have the minimum guaranteed amount (the largest individual additional profit among individual additional profits calculated when the event is successful/the target amount of product sales) recommended by the minimum guaranteed amount calculation unit 190, after the event is successful, even if only the purchaser who have the largest individual additional profit does not cancel his or her purchase and the others cancel their purchase, it is possible to pay the individual additional profit with the guaranteed amount, thereby giving no financial loss to the seller.

Further, the minimum guaranteed amount is desirably determined by dividing an event deposit by the target amount of product sales. As mentioned below, if the purchaser performs a purchase cancel response after the event is successful, the amount calculated by subtracting the guaranteed amount from the sales price is returned to the purchaser, and the guaranteed amount is paid to the seller. In case where the event is set to have the minimum guaranteed amount (the event deposit/the target amount of product sales) recommended by the minimum guaranteed amount calculation unit 190, even if all of the purchasers cancel their purchase after the event is successful, the whole guaranteed amount that is the same as the event deposit is paid to the seller, so that the seller can receive the event deposit back, without any financial loss.

The event management unit 130 transmits a message that the amount corresponding to the additional profit, as the event deposit, must be deposited into the system account unit 150, to the seller terminal 10. Through the seller terminal 10, the seller requests the event management unit 130 to transfer the event deposit having the same amount as the additional profit from the cyber money account and/or cash account connected to the seller's account to the system account unit 150, and the event management unit 130 transfers the event deposit from the cyber money account and/or cash account of the seller to the system account unit 150 (at step S120). The cash may be transferred to the system account unit 150, and in case where the cash is transferred as the event deposit from the cyber money account to the system account unit 150, the withdrawal fee may occur so that the amount corresponding to the event deposit and the withdrawal fee may be withdrawn from the cyber money account.

Before the event is activated, the event management unit 130 may transmit an event notification message of notifying the members joined in the product sales promotion system 100 of the start date and start time of the event activation to the terminals of the members (at step S130). As the start date and start time of the event activation are in advance notified, the number of momentary concurrent users for the product sales promotion system 100 can be significantly increased. The event notification message that notifies the members of the event activation can ensure fair sales in case where the additional distribution way of the additional profit is determined according to the order of payment (that is, the payment certificate issue order), the order of sales price payment, or the order of purchase confirmation response. As a result, the event notification message can prevent the first occupation in the additional distribution order by the purchasers who in advance obtain the event information.

Before the activation of the event, further, the event management unit 130 may notify the members of a period of time during which it is possible to start the event, and it is possible to unexpectedly start the activation of the event within the period of time. In detail, the event management unit 130 may notify the members of a period of time during which it is possible to start the event, for example, between May 1, 2016 and May 8, 2106, and without any additional notification, the event may be activated on May 3, 2016, 1 pm.

The event management unit 130 may activate the event configured through the event configuration unit 110 by the seller terminal 10 of the seller (at step S140). Before the event is activated by the seller, the event management unit 130 may request the seller terminal 10 to deposit a system usage fee, and if it is checked that the system usage fee is deposited into the system account unit 150, the event management unit 130 may activate the event.

In the state where the event notification message is not sent to the members joined in the product sales promotion system 100 before the activation of the event, it is possible that the event is activated on the start date and time of the event, without any notification.

The event management unit 130 may activate the event after a predetermined standby period from the start time of the event, not on the start time of the event set in the event configuration unit 110 through the seller terminal 10 of the seller. In case where the additional distribution way of the additional profit is determined according to the order of payment (that is, the payment certificate issue order), the order of sales price payment, or the order of purchase confirmation response, accordingly, fair sales can be ensured. For the predetermined standby period, in detail, the members can obtain the event information, thereby preventing the first occupation in the additional distribution order by the purchasers who in advance obtain the event information.

If the event is activated, the product may be purchased through the purchaser terminal 20 of the purchaser. The purchaser may make a payment only for the guaranteed amount or for the total sales price of the product. Hereinafter, an explanation on the case where the purchaser makes a payment only for the guaranteed amount will be given.

So as to purchase the product, the purchaser makes a payment for the guaranteed amount on the payment screen provided through the product payment unit 120 by the purchaser terminal 20, and the product payment unit 120 deposits the paid guaranteed amount into the system account unit 150 (at step S150). The paid guaranteed amount may be cash and/or cyber money withdrawn from the cyber money account and/or cash account of the purchaser, card sales amount received from a credit card company of the purchaser, and payment amount received from a smart phone communication company of the purchaser. The payment ways include known online payment ways, and a detailed explanation on the payment ways will be omitted.

If the payment for the guaranteed amount is made, the event management unit 130 may issue the payment certificate and may transmit the payment certificate to the purchaser terminal 20 (at step S160).

Whenever the event management unit 130 issues the payment certificates for the respective purchasers, it checks whether the event is successful (at step S170). The event management unit 130 may check whether the target amount of product sales is reached by the purchase of the purchaser who makes payment for the guaranteed amount. If it is checked that the event is successful by the purchase of the purchaser who makes payment for the guaranteed amount, the additional profit starts to be distributed to the other purchasers who have purchased the products, have performed the purchase confirmation responses and have been waiting for the event success. The distribution of the additional profit will be explained later.

The event management unit 130 may transmit a sales price additional payment request message to the purchaser terminal 20 of a purchaser who makes a payment only for the guaranteed amount (hereinafter, referred to as a “guaranteed amount payment purchaser”) (at step S180).

The guaranteed amount payment purchaser who receives the sales price additional payment request message may make a sales price additional payment on the payment screen provided by the product payment unit 120 through the purchaser terminal 20 (at step S190). If the additional payment for the sales price is not made by the terminal 20 of the guaranteed amount payment purchaser within a period of additional payment expiration, the event management unit 130 determines that the guaranteed amount payment purchaser cancels his or her purchase, and the guaranteed amount may be sent to the cyber money account and/or the cash account of the seller at the moment or after the event is finished.

If the guaranteed amount payment purchaser makes the sales price additional payment, the event management unit 130 returns the guaranteed amount to a guaranteed amount payment purchaser who makes the sales price additional payment (hereinafter, referred to as a “sales price additional payment purchaser”) (at step S200). The guaranteed amount is withdrawn from the amount kept in the system account unit 150 and is transferred to the cyber money account and/or the cash account of the sales price additional payment purchaser.

The delivery management unit 170 may transmit a delivery address and a payment certificate of the sales price additional payment purchaser to the seller terminal 10 to allow the seller to deliver the product to the sales price additional payment purchaser (at step S210). A delivery way may include a delivery service and a direct delivery to the purchaser, and if the product is delivered directly to the purchaser, the seller scans bar codes on the payment certificate provided by the sales price additional payment purchaser. After the sales price additional payment purchaser is identified, accordingly, the product is taken over to the sales price additional payment purchaser.

The purchase confirmation management unit 180 may transmit the purchase confirmation request to the sales price additional payment purchaser who receives the product through the delivery service or directly receives the product from the seller (at step S220).

The purchase confirmation management unit 180 may receive the response to the purchase confirmation request from the sales price additional payment purchaser (at step S230). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the sales price additional payment purchaser, the profit distribution unit 140 may pay the basic profit to the sales price additional payment purchaser in the form of cyber money (at step S240). The basic profit is withdrawn from the amount kept in the system account unit 150 and is then transferred to the cyber money account of the sales price additional payment purchaser. The basic profit is paid in cyber money, but it is possible that the basic profit is transferred, in cash, to the cash account of the sales price additional payment purchaser.

After the basic profit is paid through the profit distribution unit 140, the event management unit 130 may check whether the event is successful (at step S250). If the event management unit 130 checks that the number of payment certificates issued by the payments (inclusive of the sales price payments and the guaranteed amount payments) for the products reaches the target amount of product sales, it is determined that the event is successful, and the profit distribution unit 140 may pay an individual additional profit calculated from the additional profit, in cyber money, to the sales price additional payment purchaser who performs the purchase confirmation response (at step S260). The profit distribution unit 140 may apply the additional distribution way of the additional profit and the additional distribution rate of the additional profit to the additional profit to calculate the individual additional profit. The individual additional profit may be withdrawn from the amount kept in the system account unit 150 and may be transferred to the cyber money account of the sales price additional payment purchaser who performs the purchase confirmation response. The additional profit is paid in cyber money, but it is possible that the additional profit is transferred, in cash, to the cash account of the sales price additional payment purchaser who performs the purchase confirmation response.

After the basic profit is paid through the profit distribution unit 140 (at the step S240) and the individual additional profit is paid through the profit distribution unit 140 (at the step S260), the event management unit 130 may transfer the sales amount calculated by subtracting the sum of the total basic profits (calculated by multiplying the basic profit by the number of purchase confirmed products) and the paid individual additional profits from the total sales amount (calculated by multiplying the sales price by the number of purchase confirmed products) to the cyber money account and/or the cash account of the seller (at step S270) and may return the event deposit in the system account unit 150 to the cyber money account and/or the cash account of the seller (at step S280). In this case, an explanation on the steps S240, S260, S270 and S280 which are sequentially performed is paid, but the steps may be performed concurrently or in a reverse order to each other. If the event management unit 130 checks that the number of payment certificates issued by the payments (inclusive of the sales price payments and the guaranteed amount payments) for the products does not reach the target amount of product sales (at the step S250), it is determined that the event fails. If the event fails, the step of distributing the individual additional profit (at the step S260) is not performed.

If the event fails, the event management unit 130 may pay the basic profit (at the step S240), and next, the event management unit 130 may transfer the sales amount calculated by subtracting the total basic profits (calculated by multiplying the basic profit by the number of purchase confirmed products) from the total sales amount (calculated by multiplying the sales price by the number of purchase confirmed products) to the cyber money account and/or the cash account of the seller (at the step S270) and may return the event deposit in the system account unit 150 to the cyber money account and/or the cash account of the seller (at the step S280). In this case, an explanation on the steps S240, S270 and S280 which are sequentially performed is paid, but the steps may be performed concurrently or in a reverse order to each other.

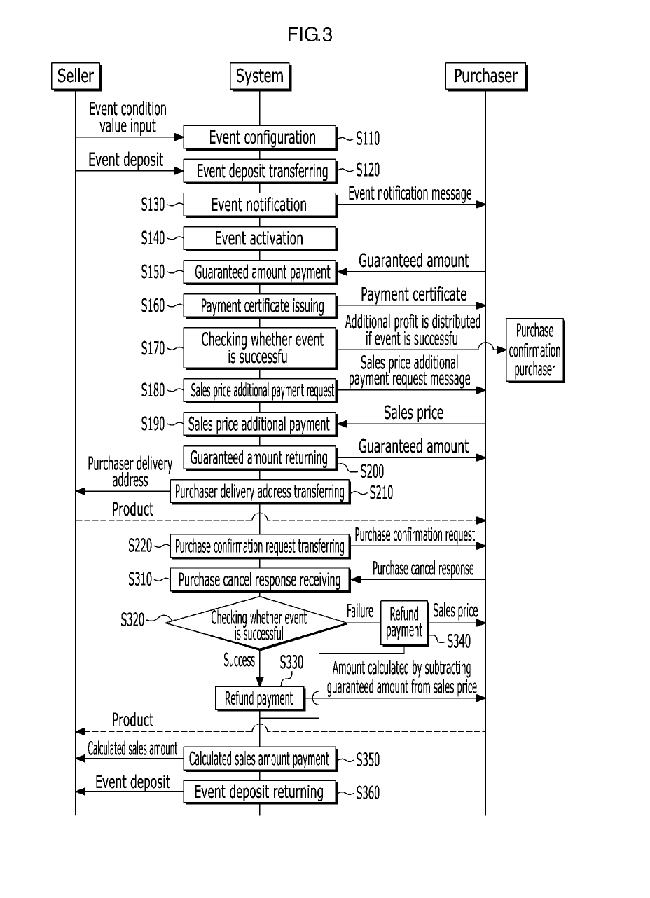

FIG. 3 is an exemplary flowchart showing the case where the purchase confirmation management unit 180 at the step S230 of FIG. 2 receives the purchase cancel response from the sales price additional payment purchaser, wherein since the steps S110 to S220 are the same as those of FIG. 2, an explanation on them will be omitted, and accordingly, the step S230 of FIG. 2 (corresponding to step S310 of FIG. 3) and the steps after the step S230 will be explained in detail.

The purchase confirmation management unit 180 may transmit the purchase confirmation request to the sales price additional payment purchaser (at the step S230).

The purchase confirmation management unit 180 may receive the response to the purchase confirmation request from the sales price additional payment purchaser (at the step S230). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund in case where the purchased product is unsatisfied.

If the purchase confirmation management unit 180 receives the purchase cancel response from the sales price additional payment purchaser (at step S310), the event management unit 130 may check whether the event is successful (at step S320). If the event management unit 130 checks that the number of payment certificates issued by the payments (inclusive of the sales price payments and the guaranteed amount payments) for the products reaches the target amount of product sales, it is determined that the event is successful, and if the event management unit 130 checks that the number of payment certificates issued does not reach the target amount of product sales, it is determined that the event fails.

If the event is successful, the profit distribution unit 140 pays the amount calculated by subtracting the guaranteed amount from the sales price, as a refund, to the sales price additional payment purchaser who performs the purchase cancel response (at step S330). The refund may be withdrawn from the amount kept in the system account unit 150 and thus may be transferred to the cyber money account and/or the cash account of the sales price additional payment purchaser who performs the purchase cancel response. The reason why the guaranteed amount is subtracted from the sales price is that it can be used to pay the additional profit according to the event success to other purchasers who perform the purchase confirmation response. If the sales price additional payment purchaser performs the purchase cancel even upon the event success, his or her guaranteed amount is lost, so that he or she cannot select the purchase cancel response easily.

After the profit distribution unit 140 pays the basic profit and the individual additional profits to the purchasers who perform the purchase confirmation response, the event management unit 130 may transfer the sales amount calculated by subtracting the sum of the total basic profits (calculated by multiplying the basic profit by the number of purchase confirmed products) and the paid individual additional profits from the total sales amount (calculated by multiplying the sales price by the number of purchase confirmed products) to the cyber money account and/or the cash account of the seller (at step S350) and may return the event deposit in the system account unit 150 to the cyber money account and/or the cash account of the seller (at step S360).

In this case, the purchase confirmation management unit 180 may receive the purchase cancel response from the sales price additional payment purchaser (at the step S310), and after the event management unit 130 checks that the event is successful (at the step S320), the profit distribution unit 140 may pay the refund (calculated by subtracting the guaranteed amount from the sales price) to the sales price additional payment purchaser who performs the purchase cancel response (at the step S330).

Alternatively, if the purchase confirmation management unit 180 receives the purchase cancel response from the sales price additional payment purchaser, the profit distribution unit 140 may pay the refund (calculated by subtracting the guaranteed amount from the sales price) to the sales price additional payment purchaser who performs the purchase cancel response, and then, the event management unit 130 may check whether the event is successful. If it is checked that the event is successful, the guaranteed amount is not paid to the sales price additional payment purchaser who performs the purchase cancel response. The guaranteed amount may be immediately paid to the seller.

If the event fails (at the step S320), the profit distribution unit 140 may pay the amount corresponding to the sales price as the refund to the sales price additional payment purchaser who performs the purchase cancel response (at step S340). The refund may be withdrawn from the amount kept in the system account unit 150 and thus may be transferred to the cyber money account and/or the cash account of the sales price additional payment purchaser who performs the purchase cancel response. The reason why the guaranteed amount is not subtracted from the sales price is opposite to the reason why the guaranteed amount is subtracted from the sales price upon the event success. That is, the reason is that the additional profit is not paid to other purchasers who perform the purchase confirmation response because the event fails.

After the profit distribution unit 140 pays the basic profit to the purchasers who perform the purchase confirmation response, the event management unit 130 may transfer the sales amount calculated by subtracting the total basic profit (calculated by multiplying the basic profit by the number of purchase confirmed products) from the total sales price (calculated by multiplying the sales price by the number of purchase confirmed products) to the cyber money account and/or the cash account of the seller (at the step S350) and may return the event deposit in the system account unit 150 to the cyber money account and/or the cash account of the seller (at the step S360).

In this case, the purchase confirmation management unit 180 may receive the purchase cancel response from the sales price additional payment purchaser (at the step S310), and after the event management unit 130 checks that the event fails (at the step S320), the profit distribution unit 140 may pay the refund (corresponding to the sales price) to the sales price additional payment purchaser who performs the purchase cancel response (at the step S340).

Alternatively, if the purchase confirmation management unit 180 receives the purchase cancel response from the sales price additional payment purchaser, the profit distribution unit 140 firstly pays the refund (calculated by subtracting the guaranteed amount from the sales price) to the sales price additional payment purchaser who performs the purchase cancel response, and then, the event management unit 130 may check whether the event is successful. If it is checked that the event fails, the guaranteed amount may be secondarily paid to the sales price additional payment purchaser who performs the purchase cancel response.

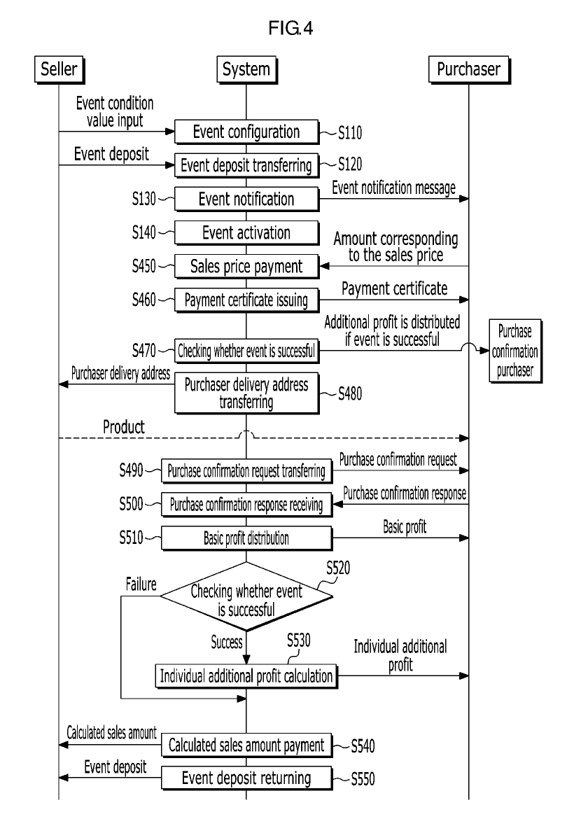

FIG. 4 is an exemplary flowchart showing processes of selling products and distributing sales profit in the product sales promotion system according to an embodiment of the disclosed technology, wherein the purchaser makes a payment for the sales price on the event configured by the seller and performs the purchase confirmation response.

Since the steps S110 to S140 are the same as those of FIG. 2, an explanation on them will be omitted, and accordingly, the step S150 of FIG. 2 (corresponding to step S450 of FIG. 4) and the steps after the step S150 will be in detail explained.

If the event is activated through the event management unit 130 (at the step S140), the purchaser may purchase the product through the purchaser terminal 20. The purchaser may make a payment only for the guaranteed amount or for the whole sales price, and hereinafter, an explanation on the case where the purchaser makes a payment for the sales price will be given.

So as to purchase the product, the purchaser may make a payment for the sales price on the payment screen provided by the product payment unit 120 through the purchaser terminal 20, and the product payment unit 120 may deposit the paid amount of the sales price into the system account unit 150 (at step S450). The paid amount of sales price may be cash and/or cyber money withdrawn from the cyber money account and/or cash account of the purchaser, card sales amount received from a credit card company of the purchaser, and payment amount received from a smart phone communication company of the purchaser. The payment ways include known online payment ways, and a detailed explanation on the payment ways will be omitted.

If the payment for the sales price is made, the event management unit 130 may issue the payment certificate and may transmit the payment certificate to the purchaser terminal 20 (at step S460).

Whenever the event management unit 130 issues the payment certificates for the respective purchasers, it checks whether the event is successful (at step S470). The event management unit 130 may check whether the target amount of product sales is reached by the purchase of the purchaser who makes payment for the sales price. If it is checked that the event is successful by the purchase of the purchaser who makes a payment for the sales price, the additional profit starts to be distributed to the other purchasers who have purchased the products, have performed the purchase confirmation responses, and have been waiting for the event success.

The delivery management unit 170 may transmit a delivery address and a payment certificate of a purchaser who makes a payment for the sales price (hereinafter, referred to as a “sales price payment purchaser”) to the seller terminal 10 to allow the seller to deliver the product to the sales price payment purchaser (at step S480). A delivery way may include a delivery service and a direct delivery to the purchaser, and if the product is delivered directly to the purchaser, the seller scans bar codes on the payment certificate provided by the sales price payment purchaser. After the sales price payment purchaser is identified, accordingly, the product is taken over to the sales price payment purchaser.

The purchase confirmation management unit 180 may transmit the purchase confirmation request to the sales price payment purchaser who receives the product through the delivery service or directly receives the product from the seller (at step S490).

The purchase confirmation management unit 180 may receive the response to the purchase confirmation request from the sales price payment purchaser (at step S500). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the sales price payment purchaser, the profit distribution unit 140 may pay the basic profit to the sales price payment purchaser in the form of cyber money (at step S510). The basic profit is withdrawn from the amount kept in the system account unit 150 and is then transferred to the cyber money account of the sales price payment purchaser. The basic profit is paid in cyber money, but it is possible that the basic profit is transferred, in cash, to the cash account of the sales price payment purchaser.

After the basic profit is paid through the profit distribution unit 140, the event management unit 130 may check whether the event is successful (at step S520). If the event management unit 130 checks that the number of payment certificates issued by the payments (inclusive of the sales price payments and the guaranteed amount payments) for the products reaches the target amount of product sales, it is determined that the event is successful, and the profit distribution unit 140 may pay an individual additional profit calculated from the additional profit, in cyber money, to the sales price payment purchaser who performs the purchase confirmation response (at step S530). The profit distribution unit 140 may apply the additional distribution way of the additional profit and the additional distribution rate of the additional profit to the additional profit to calculate the individual additional profit. The individual additional profit may be withdrawn from the amount kept in the system account unit 150 and may be transferred to the cyber money account of the sales price payment purchaser who performs the purchase confirmation response. The additional profit is paid in cyber money, but it is possible that the additional profit is transferred in cash to the cash account of the sales price payment purchaser who performs the purchase confirmation response.

After the profit distribution unit 140 pays the basic profit (at the step S510) and pays the individual additional profit (at the step S530), the event management unit 130 may transfer the sales amount calculated by subtracting the sum of the total basic profit (calculated by multiplying the basic profit by the number of purchase confirmed products) and the paid individual additional profits from the total sales amount (calculated by multiplying the sales price by the number of purchase confirmed products) to the cyber money account and/or the cash account of the seller (at step S540) and may return the event deposit in the system account unit 150 to the cyber money account and/or the cash account of the seller (at step S550). In this case, an explanation on the steps S510, S530, S540, and S550 which are sequentially performed is paid, but the steps may be performed concurrently or in a reverse order to each other.

If the event management unit 130 checks that the number of payment certificates issued by the payments (inclusive of the sales price payments and the guaranteed amount payments) for the products does not reach the target amount of product sales (at the step S520), it is determined that the event fails. If the event fails, the step of distributing the individual additional profit (at the step S520) is not performed.

If the event fails, the event management unit 130 may pay the basic profit (at the step S510), and next, the event management unit 130 may transfer the sales amount calculated by subtracting the total basic profit (calculated by multiplying the basic profit by the number of purchase confirmed products) from the total sales price (calculated by multiplying the sales price by the number of purchase confirmed products) to the cyber money account and/or the cash account of the seller (at the step S540) and may return the event deposit in the system account unit 150 to the cyber money account and/or the cash account of the seller (at the step S550). In this case, an explanation on the steps S510, S540 and S550 which are sequentially performed is paid, but the steps may be performed concurrently or in a reverse order to each other.

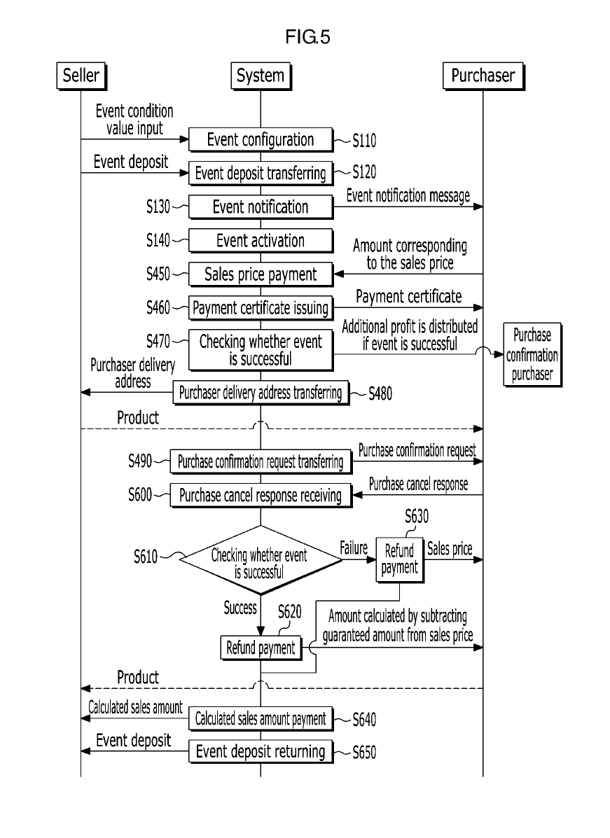

FIG. 5 is an exemplary flowchart showing the case where the purchase confirmation management unit 180 at the step S500 of FIG. 4 receives the purchase cancel response from the sales price payment purchaser, wherein since the steps S110 to S140 and the steps S450 to S490 are the same as those of FIG. 4, an explanation on them will be omitted, and accordingly, the step S500 of FIG. 4 (corresponding to step S600 of FIG. 5) and the steps after the step S500 will be explained in detail.

The purchase confirmation management unit 180 may transmit the purchase confirmation request to the sales price payment purchaser (at the step S490).

The purchase confirmation management unit 180 may receive the response to the purchase confirmation request from the sales price payment purchaser (at step S600). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund in case where the purchased product is unsatisfied.

If the purchase confirmation management unit 180 receives the purchase cancel response from the sales price payment purchaser (at the step S600), the event management unit 130 may check whether the event is successful (at step S610). If the event management unit 130 checks that the number of payment certificates issued by the payments (inclusive of the sales price payments and the guaranteed amount payments) for the products reaches the target amount of product sales, it is determined that the event is successful, and if the event management unit 130 checks that the number of payment certificates issued does not reach the target amount of product sales, it is determined that the event fails.

If the event is successful, the profit distribution unit 140 pays the amount calculated by subtracting the guaranteed amount from the sales price, as s refund, to the sales price payment purchaser who performs the purchase cancel response (at step S620). The refund may be withdrawn from the amount kept in the system account unit 150 and thus may be transferred to the cyber money account and/or the cash account of the sales price payment purchaser who performs the purchase cancel response. The reason why the guaranteed amount is subtracted from the sales price is that it can be used to pay the additional profit according to the event success to other purchasers who perform the purchase confirmation response. If the sales price payment purchaser performs the purchase cancel even upon the event success, his or her guaranteed amount is lost, so that he or she cannot select the purchase cancel response easily.

After the profit distribution unit 140 pays the basic profit and the individual additional profit to each of the purchasers who perform the purchase confirmation response, the event management unit 130 may transfer the sales amount calculated by subtracting the sum of the total basic profit (calculated by multiplying the basic profit by the number of purchase confirmed products) and the paid individual additional profits from the total sales amount (calculated by multiplying the sales price by the number of purchase confirmed products) to the cyber money account and/or the cash account of the seller (at step S640) and may return the event deposit in the system account unit 150 to the cyber money account and/or the cash account of the seller (at step S650).

In this case, the purchase confirmation management unit 180 may receive the purchase cancel response from the sales price payment purchaser (at the step S600), and after the event management unit 130 checks that the event is successful (at the step S610), the profit distribution unit 140 may pay the refund (calculated by subtracting the guaranteed amount from the sales price) to the sales price payment purchaser who performs the purchase cancel response (at the step S620).

Alternatively, if the purchase confirmation management unit 180 receives the purchase cancel response from the sales price payment purchaser, the profit distribution unit 140 may pay the refund (calculated by subtracting the guaranteed amount from the sales price) to the sales price payment purchaser who performs the purchase cancel response, and then, the event management unit 130 may check whether the event is successful. If it is checked that the event is successful, the guaranteed amount is not paid to the sales price payment purchaser who performs the purchase cancel response. The guaranteed amount may be immediately paid to the seller.

If the event fails (at the step S610), the profit distribution unit 140 may pay the amount corresponding to the sales price as a refund to the sales price payment purchaser who performs the purchase cancel response (at step S630). The refund may be withdrawn from the amount kept in the system account unit 150 and thus may be transferred to the cyber money account and/or the cash account of the sales price payment purchaser who performs the purchase cancel response. The reason why the guaranteed amount is not subtracted from the sales price is opposite to the reason why the guaranteed amount is subtracted from the sales price upon the event success. That is, the reason is that the additional profit is not paid to other purchasers who perform the purchase confirmation response because the event fails.

After the profit distribution unit 140 pays the basic profit to the purchasers who perform the purchase confirmation response, the event management unit 130 may transfer the sales amount calculated by subtracting the total basic profit (calculated by multiplying the basic profit by the number of purchase confirmed products) from the total sales price (calculated by multiplying the sales price by the number of purchase confirmed products) to the cyber money account and/or the cash account of the seller (at the step S640) and may return the event deposit in the system account unit 150 to the cyber money account and/or the cash account of the seller (at the step S650).

In this case, the purchase confirmation management unit 180 may receive the purchase cancel response from the sales price payment purchaser (at the step S600), and after the event management unit 130 checks that the event fails (at the step S610), the profit distribution unit 140 may pay the refund (corresponding to the sales price) to the sales price payment purchaser who performs the purchase cancel response (at the step S630).

Alternatively, if the purchase confirmation management unit 180 receives the purchase cancel response from the sales price payment purchaser, the profit distribution unit 140 firstly pays the refund (calculated by subtracting the guaranteed amount from the sales price) to the sales price payment purchaser who performs the purchase cancel response, and then, the event management unit 130 may check whether the event is successful. If it is checked that the event fails, the guaranteed amount may be secondarily paid to the sales price payment purchaser who performs the purchase cancel response.

An expected additional distribution order in the product sales promotion system and method according to an embodiment of the disclosed technology may be calculated before the purchase confirmation responses of the guaranteed amount payment purchasers and the sales price payment purchasers are completed. Whenever the payment certificates are issued by the event management unit 130, the profit distribution unit 140 may calculate an expected additional distribution order of the guaranteed amount payment purchasers and the sales price payment purchasers in real time to transmit the real time expected additional distribution order to the terminals 20 of the guaranteed amount payment purchasers and the sales price payment purchasers.

In this case, of course, the profit distribution unit 140 may not publish the real time expected additional distribution order until the event is successful, and after the event is successful, the profit distribution unit 140 may transmit the real time expected additional distribution order to the terminals 20 of the guaranteed amount payment purchasers and the sales price payment purchasers. Until the event is successful, as a result, the guaranteed amount payment purchasers and the sales price payment purchasers cannot obtain the information on their real time expected additional distribution order, so that such uncertainty in the real time expected additional distribution order makes purchase desires more stimulated, thereby allowing the event to be successful within a shorter period of time.

The additional distribution way of the additional profit in the product sales promotion system and method according to an embodiment of the disclosed technology may be selected by the seller. For example, the additional distribution way of the additional profit may be determined according to the order of payment (that is, the payment certificate issue order), an amount of cyber money retained, the order of sales price payment, or the order of purchase confirmation response.

The additional distribution way of the additional profit according to the order of payment may be carried out by arranging purchasers who perform the purchase confirmation responses (hereinafter, referred to as “purchase confirmation purchasers”) in the order of payment. In this case, the payment may include both of the guaranteed amount payment and the sales price payment. First, a first individual additional profit calculated by multiplying the additional profit by an additional distribution rate may be paid to a first purchase confirmation purchaser who performs the earliest payment among the purchase confirmation purchasers, and next, a second individual additional profit calculated by multiplying the amount remained after subtracting the first individual additional profit from the additional profit by the additional distribution rate may be paid to a second purchase confirmation purchaser who performs the payment in the second earliest among the purchase confirmation purchasers.

The additional distribution way of the additional profit according to the amount of cyber money retained may be carried out by arranging the purchase confirmation purchasers in the order of a value calculated by multiplying the cyber money amount of the cyber money account included in the account of the purchase confirmation purchaser by the number of payment certifications issued to the purchase confirmation purchaser (hereinafter, referred to as a “multiplied value for order”). In this case, the cyber money deposited into the cyber money account may further include at least one selected from the group of the cyber money exchanged from the cash of the purchase confirmation purchaser, the basic profits transferred from other events, the additional profits transferred from other events and the cyber money generated by activities of the member joined in the product sales promotion system 100. Then, a first individual additional profit calculated by multiplying the additional profit by the additional distribution rate may be paid to a first purchase confirmation purchaser who has the largest multiplied value for order among the purchase confirmation purchasers, and next, a second individual additional profit calculated by multiplying the amount remained after subtracting the first individual additional profit from the additional profit by the additional distribution rate may be paid to a second purchase confirmation purchaser who has the second largest multiplied value for order among the purchase confirmation purchasers. For example, if one purchase confirmation purchaser receives five payment certificates, the multiplied value for order of the purchase confirmation purchaser is calculated as the amount of cyber money retained*5.

The additional distribution way of the additional profit according to the order of sales price payment may be carried out by arranging the purchase confirmation purchasers in the order of sales price payment. In this case, the sales price payment may include both of the sales price payment after the payment of the guaranteed amount and the sales price payment having no guaranteed amount payment. First, a first individual additional profit calculated by multiplying the additional profit by the additional distribution rate may be paid to a first purchase confirmation purchaser who performs the earliest sales price payment among the purchase confirmation purchasers, and next, a second individual additional profit calculated by multiplying the amount remained after subtracting the first individual additional profit from the additional profit by the additional distribution rate may be paid to a second purchase confirmation purchaser who performs the sales price payment in the second earliest among the purchase confirmation purchasers.

The additional distribution way of the additional profit according to the order of purchase confirmation response may be carried out by arranging the purchase confirmation purchasers in the order of purchase confirmation response. First, a first individual additional profit calculated by multiplying the additional profit by the additional distribution rate may be paid to a first purchase confirmation purchaser who performs the earliest purchase confirmation response among the purchase confirmation purchasers, and next, a second individual additional profit calculated by multiplying the amount remained after subtracting the first individual additional profit from the additional profit by the additional distribution rate may be paid to a second purchase confirmation purchaser who performs the purchase confirmation response in the second earliest among the purchase confirmation purchasers.

In the additional distribution ways of the additional profit as mentioned above, examples only for the first and second purchase confirmation purchasers are suggested, but in the same manner as above, individual additional profits may be paid to the purchase confirmation purchasers in the post-order. For example, a third individual additional profit calculated by multiplying the amount remained after subtracting the first individual additional profit and the second individual additional profit from the additional profit by the additional distribution rate may be paid to a third purchase confirmation purchaser.

If the additional profit remains after the individual additional profits are paid to all of the purchase confirmation purchasers, another first individual additional profit calculated by multiplying the remaining additional profit by the additional distribution rate may be paid to the first purchase confirmation purchasers again and then the distribution of the remaining additional profit may proceed in the same manner as above. If the remaining additional profit is less than a predetermined amount, however, the profit distribution unit 140 may transfer the remaining additional profit to the system account unit 150 and may finish the distribution of the additional profit.

Now, an explanation on the effects obtained by the product sales promotion system and method according to an embodiment of the disclosed technology will be given with a given example.

One sales agency of a computer manufacturing company A sells a laptop computer X at a retail price of 2,000 dollars. The average number of laptop computers X sold for a month in the sales agency is 50. Actually, the laptop computer is sold at the lowest price of 1,800 dollars on on-line markets.

The sales agency determines that they sell the laptop computer X through the product sales promotion system according to an embodiment of the disclosed technology, and the event is set with the following conditions.
Sales price: 2,000 dollars
Target period of time for product sales: one month
Target amount of product sales: 2,000
Basic profit to be distributed to a purchaser: 200 dollars
Guaranteed amount: 20 dollars
Additional profit to be distributed to purchasers if the event is successful: 780,000 dollars
Additional distribution way: distribution according to cyber money amounts retained in the cyber money accounts of purchase confirmation purchasers
Additional distribution rate: 0.1%

For only one month, the sales volume of the laptop computers increases 40 times higher than the sales volume for the past one month. Therefore, the sales agency can obtain additional cash of 3,900,000 dollars (=2,000 dollars*1,950). If the sales agency sold the laptop computers in a conventional manner, it would take three years and three months to sell the 1,950 laptop computers. The sales agency decides to distribute the additional profit of 780,000 dollars corresponding to 20% of the additional cash to the purchasers.

Purchaser B is a first purchaser having the largest cyber money amount among 2,000 purchasers, Purchaser C is a second purchaser having the second largest cyber money amount among the purchasers, Purchaser D is a 500th purchaser having the 500th largest cyber money amount among the purchasers, and Purchaser E is a 2000th purchaser having the 2000th largest cyber money amount among the purchasers. In this case, the cyber money to be distributed to Purchasers B, C, D and E will be calculated as follows.

[Amount to be Paid to Purchaser B.]
Basic profit of 200 dollars
Individual additional profit of 780 dollars [=additional profit of 780,000 dollars*additional distribution rate of 0.1%))

[Amount to be Paid to Purchaser C]
Basic profit of 200 dollars
Individual additional profit of 779 dollars [=(amount of 779,220 dollars calculated by subtracting the first individual additional profit of 780 dollars from additional profit of 780,000 dollars)*(additional distribution rate of 0.1%))

[Amount to be Paid to Purchaser D]
Basic profit of 200 dollars
Individual additional profit of 473 dollars [=(amount of 473,449 dollars calculated by subtracting the individual additional profits of up to 499th purchasers from additional profit of 780,000 dollars)*(additional distribution rate of 0.1%)]

[Amount to be Paid to Purchaser E]
Basic profit of 200 dollars
Individual additional profit of 106 dollars [=(amount of 105,562 dollars calculated by subtracting the individual additional profits of up to 1999th purchasers from additional profit of 780,000 dollars)*(additional distribution rate of 0.1%)]

The guaranteed amount of 20 dollars is paid back to Purchasers B, C, D and E, respectively, and the basic profit of 200 dollars is also paid to all of them. Further, Purchasers B, C, D and E purchase the laptop computer of 1,800 dollars, which is the same price as the lowest price sold on on-line markets. According to the event success, furthermore, Purchasers B, C, D and E have got the respective individual additional profits of 780 dollars, 779 dollars, 473 dollars, and 106 dollars in the form of cyber money.

With a payment of the withdrawal fee, the cyber money in the cyber money account may be transferred to the cash account or cash may be withdrawn directly from the cyber money account, thereby increasing the cash assets of the purchaser. Further, since the order of the cyber money retention of the purchaser is raised by the cyber money distributed through this purchase, a larger amount of individual additional profit may be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in a conventional purchase system, he or she just prepares 2,000 dollars, which makes him or her feel burdened so that he or she does not purchase the laptop computer. Through the product sales promotion system 100, the sales price is paid in interest-free installments, and next, the installment amount is paid with the basic profit and the individual additional profit, thereby making the purchase burden of the purchaser disappear. Such an advantage is obtained because the value of time is turned into the cyber money. Particularly, if the additional distribution rate of the additional profit is raised by the seller, the amount of the additional profit to be distributed to the top-order purchasers is increased, so that the consumption willingness and event join willingness of the members become high. An example of such a case will be explained later.

For a short period of time, of course, the seller accomplishes a significantly larger amount of sales than an amount of sales in the past, thereby obtaining a great sales profit, and even if the additional profit is distributed, an amount of sales over several months to years can be obtained within the short period of time, so that no financial loss occurs. So as to improve the possibility of event success, further, if the additional profit or the additional distribution rate is raised by the seller, the event join desires of the members can be strongly stimulated, thereby rapidly and reliably achieving the target amount of product sales.

The product sales promotion system 100 can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members may withdraw the cyber money from their cyber money accounts and encash the cyber money, or they may get a loan against their cyber money from the product sales promotion system 100. The members can encash their cyber money with a payment of the withdrawal fees, but in this case, an amount of cyber money retained in the cyber money account is decreased to cause the additional distribution order of the event to be undesirably lowered. So as to perform the encashing of the cyber money in the state where the amount of cyber money retained is kept, accordingly, the product sales promotion system 100 may lend cash to the members with their cyber money as collateral. As a result, the product sales promotion system 100 may do a financial business.

Now, an explanation on more improved effects obtained by increasing the additional profit and the additional distribution rate of the additional profit through the seller in the product sales promotion system 100 and method according to an embodiment of the disclosed technology will be given with a given example.

A famous fitness center A sells a three-year membership X at a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold at the fitness center A is 1,650 dollars.

The fitness center A determines that they sell the three-year membership X through the product sales promotion system according to an embodiment of the disclosed technology, and the event is set with the following conditions.
Sales price: 3,000 dollars
Target period of time for product sales: one day
Target amount of product sales: 1,000
Basic profit to be distributed to a purchaser: 200 dollars
Guaranteed amount: 1,300 dollars
Additional profit to be distributed to purchasers if the event is successful: 1,300,000 dollars
Additional distribution way: distribution according to payment order of purchase confirmation purchasers
Additional distribution rate: 0.6%

For only one day, the sales volume of the three-year membership increases 100 times higher than the sales volume for the past one day. Therefore, the fitness center can obtain additional cash of 2,970,000 dollars (=3,000 dollars*990) and obtain additional sales profit of 1,633,500 dollars (=1,650 dollars*990). If the fitness center sold the three-year membership in a conventional manner, it would take at least three months to sell the 990 three-year memberships, and the 990 three-year memberships could not be ensured. The fitness center decides to distribute the additional profit of 1,300,000 dollars corresponding to 78% of the additional sales profit to the purchasers.

Purchaser B is a first purchase confirmation purchaser who performs the earliest payment among the 1,000 purchasers, Purchaser C is a second purchase confirmation purchaser who performs the second earliest payment, Purchaser D is a 500th purchase confirmation purchaser who performs the 500th earliest payment, and Purchaser E is a 1,000th purchase confirmation purchaser who performs the 1,000th earliest payment. In this case, the cyber money to be distributed to Purchasers B, C, D and E will be calculated as follows.

[Amount to be Paid to Purchaser B.]
Basic profit of 200 dollars
Individual additional profit of 7,800 dollars [=(additional profit of 1,300,000 dollars)*(additional distribution rate of 0.6%)]

[Amount to be paid to Purchaser C]
Basic Profit of 200 Dollars
Individual additional profit of 7,753 dollars [=(amount of 1,292,200 dollars calculated by subtracting the first individual additional profit of 7,800 dollars from additional profit of 1,300,000 dollars)*(additional distribution rate of 0.6%)]

[Amount to be Paid to Purchaser D]
Basic profit of 200 dollars
Individual additional profit of 387 dollars [=(amount of 64,528 dollars calculated by subtracting the individual additional profits of up to 499th purchasers from additional profit of 1,300,000 dollars)*(additional distribution rate of 0.6%)]

[Amount to be Paid to Purchaser E]
Basic profit of 200 dollars
Individual additional profit of 19 dollars [=(amount of 3,184 dollars calculated by subtracting the individual additional profits of up to 999th purchasers from additional profit of 1,300,000 dollars)*(additional distribution rate of 0.6%)]

The guaranteed amount of 1,300 dollars is paid back to Purchasers B, C, D and E, respectively, and the basic profit of 200 dollars is also paid to all of them. Further, Purchasers B, C, D and E purchase the three-year membership of 2,800 dollars, which is the same price as the lowest price sold on on-line markets. According to the event success, furthermore, Purchasers B, C, D and E have got the respective individual additional profits of 7,800 dollars, 7,753 dollars, 387 dollars, and 19 dollars in the form of cyber money.

With a payment of the withdrawal fee, the cyber money in the cyber money account may be transferred to the cash account or cash may be withdrawn directly from the cyber money account, thereby increasing the cash assets of the purchaser. Further, Purchasers B and C can earn a great amount of money, which is more than the price of the three-year membership. Their wealth is increased through their consumption.

Through the two examples as mentioned above, it can be appreciated that the product sales promotion system 100 according to an embodiment of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

The embodiments of the disclosed technology solve the problems accompanying in E-commerce promotion by introducing the guaranteed amount system operated in a unique manner using an electronic communication network, such as Internet, and computer system. The embodiments of the disclosed technology promote the rapid success of an event by setting the event success merely with the payment of the guaranteed amount. The embodiments of the disclosed technology encourage the purchaser to pay the remaining sales price by providing the amount of the additional profit to be distributed through the electronic communication network and computer system. The embodiments of the disclosed technology provide a loss prevention system for the seller using the electronic communication network and computer system, in which refund after distributing the additional profit is prevented and the guarantee amount is refunded or not refunded in accordance with the situation.

While the disclosed technology has been described with reference to the particular illustrative embodiments, it is not to be restricted by the embodiments but only by the appended claims. It is to be appreciated that those skilled in the art can change or modify the embodiments without departing from the scope and spirit of the disclosed technology.

### EXPLANATION ON REFERENCE NUMERALS

10: seller terminal
20: purchaser terminal
100: product sales promotion system
110: event configuration unit
120: product payment unit
130: event management unit
140: profit distribution unit
150: system account unit
160: member account unit
170: delivery management unit
180: purchase confirmation management unit
190: minimum guaranteed amount calculation unit

What is claimed is:

1. A product sales promotion system comprising:
an event configuration unit adapted to receive at least one of sales price of a product, a target period of time for product sales, a target amount of product sales, and a basic profit to be distributed to a purchaser from a terminal of a seller, to set an event which is decided to be successful when the target amount of product sales is reached within the target period of time according to an input from the terminal of the seller, and to receive at least one of an amount of an additional profit to be distributed to the purchaser when the event is successful, an additional distribution way of the additional profit, and an additional distribution rate of the additional profit from the terminal of the seller;
a product payment unit adapted to receive a payment for the product from a terminal of the purchaser;
an event management unit adapted to activate the event and to check whether the number of payments for the product received by the product payment unit reaches the target amount of product sales; and
a profit distribution unit adapted to pay the basic profit to the purchaser and, when the event management unit decides that the event is successful, to pay the additional profit to the purchaser.

2. The product sales promotion system according to claim 1, wherein before the event is activated, the event management unit transmits an event notification message for notifying a start date and a start time of the event activation to a terminal of a member joined in the product sales promotion system.

3. The product sales promotion system according to claim 1, wherein the event management unit activates the event after a predetermined standby period from a start time of the event activation.

4. The product sales promotion system according to claim 1, wherein the event configuration unit receives a guaranteed amount lower than the sales price of the product from the terminal of the seller, and the payment received by the event management unit is the payment for the guaranteed amount or for the sales price.

5. The product sales promotion system according to claim 4, further comprising:
a system account unit adapted to deposit an amount given by the payment; and
a member account unit allocated to the member joined in the product sales promotion system, the member account unit adapted to deposit at least one of cyber money and cash.

6. The product sales promotion system according to claim 5, wherein before or at the same time as the event activation starts, an event deposit of the seller which is the same amount as the additional profit is transferred from the member account unit of the seller to the system account unit.

7. The product sales promotion system according to claim 6, wherein the event management unit transmits a sales price additional payment request to a terminal of a purchaser who made a payment only for the guaranteed amount (hereinafter, referred to as a “guaranteed amount payment purchaser”), and when the guaranteed amount payment purchaser makes a sales price additional payment through the terminal of the guaranteed amount payment purchaser to the product payment unit, the event management unit transfers an amount corresponding to the guaranteed amount from an amount deposited in the system account unit to the member account unit of a guaranteed amount payment purchaser who makes the sales price additional payment (hereinafter, referred to as a “sales price additional payment purchaser”).

8. The product sales promotion system according to claim 7, further comprising a delivery management unit adapted to transmit a delivery address of a purchaser who makes a payment for the sales price without a payment for the guaranteed amount (hereinafter, referred to as a “sales price payment purchaser”) and/or a delivery address of the sales price additional payment purchaser to the terminal of the seller.

9. The product sales promotion system according to claim 8, further comprising a purchase confirmation management unit adapted to transmit a purchase confirmation request to the terminal of the sales price payment purchaser and/or the terminal of the sales price additional payment purchaser, and to receive a response to the purchase confirmation request from the terminal of the sales price payment purchaser and/or the terminal of the sales price additional payment purchaser,
wherein when the response to the purchase confirmation request is a purchase confirmation response, the profit distribution unit transfers the basic profit from the system account unit to the member account units of the sales price payment purchaser and/or the sales price additional payment purchaser, and
wherein when the response to the purchase confirmation request is a purchase cancel response, the profit distribution unit transfers an amount corresponding to the sales price to the member account units of the sales price payment purchaser and/or the sales price additional payment purchaser, but when the event management unit decides that the event is successful, the profit distribution unit transfers an amount calculated by subtracting an amount corresponding to the guaranteed amount from the amount corresponding to the sales price to the member account units of the sales price payment purchaser and/or the sales price additional payment purchaser.

10. The product sales promotion system according to claim 8, further comprising a purchase confirmation management unit adapted to transmit a purchase confirmation request to the terminal of the sales price payment purchaser and/or the terminal of the sales price additional payment purchaser, and to receive a response to the purchase confirmation request from the terminal of the sales price payment purchaser and/or the terminal of the sales price additional payment purchaser,
wherein when the response to the purchase confirmation request is a purchase confirmation response, the profit distribution unit transfers the basic profit from the system account unit to the member account units of the sales price payment purchaser and/or the sales price additional payment purchaser, and
wherein when the response to the purchase confirmation request is a purchase cancel response, the profit distribution unit transfers an amount calculated by subtracting an amount corresponding to the guaranteed amount from the sales price to the member account units of the sales price payment purchaser and/or the sales price additional payment purchaser, and when the event management unit decides that the event fails, the profit distribution unit transfers an amount corresponding to the guaranteed amount to the member account units of the sales price payment purchaser and/or the sales price additional payment purchaser.

11. The product sales promotion system according to claim 9, wherein when the event management unit decides that the event is successful, the profit distribution unit determines individual additional profits to be distributed to the sales price payment purchaser and/or the sales price additional payment purchaser who transmitted the purchase confirmation response (hereinafter, referred to as “purchase confirmation purchasers”) by applying the additional distribution way and the additional distribution rate of the additional profit, and the profit distribution unit transfers the individual additional profits from an amount kept in the system account unit to the member account units of the purchase confirmation purchasers.

12. The product sales promotion system according to claim 11, further comprising a minimum guaranteed amount calculation unit adapted to notify the terminal of the seller of a minimum guaranteed amount, when the event configuration unit receives the guaranteed amount from the terminal of the seller,
wherein the minimum guaranteed amount is calculated by dividing a largest individual additional profit among the individual additional profits which are calculated when the event is successful by the target amount of product sales.

13. The product sales promotion system according to claim 11, further comprising a minimum guaranteed amount calculation unit adapted to notify the terminal of the seller of a minimum guaranteed amount, when the event configuration unit receives the guaranteed amount from the terminal of the seller,
wherein the minimum guaranteed amount is calculated by dividing the event deposit by the target amount of product sales.

14. The product sales promotion system according to claim 11, wherein the additional distribution way comprises:
arranging the purchase confirmation purchasers in an order of payment;
paying a first individual additional profit calculated by multiplying the additional profit by the additional distribution rate of the additional profit to a first purchase confirmation purchaser who performs an earliest payment among the purchase confirmation purchasers; and
paying a second individual additional profit calculated by multiplying an amount remained after subtracting the first individual additional profit from the additional profit by the additional distribution rate of the additional profit to a second purchase confirmation purchaser who performs a payment in the second earliest among the purchase confirmation purchasers.

15. The product sales promotion system according to claim 11, wherein the member account unit comprises a cyber money account in which cyber money is deposited, and
wherein the additional distribution way comprises:
arranging the purchase confirmation purchasers in an order of a value calculated by multiplying the cyber money amount of the cyber money account of the purchase confirmation purchaser by the number of payments of the purchase confirmation purchaser (hereinafter, referred to as a “multiplied value for order”);
paying a first individual additional profit calculated by multiplying the additional profit by the additional distribution rate of the additional profit to a first purchase confirmation purchaser who has a largest multiplied value for order among the purchase confirmation purchasers; and
paying a second individual additional profit calculated by multiplying an amount remained after subtracting the first individual additional profit from the additional profit by the additional distribution rate of the additional profit to a second purchase confirmation purchaser who has a second largest multiplied value for order among the purchase confirmation purchasers.

16. The product sales promotion system according to claim 10, wherein when the event management unit decides that the event is successful, the profit distribution unit determines individual additional profits to be distributed to the sales price payment purchaser and/or the sales price additional payment purchaser who transmitted the purchase confirmation response (hereinafter, referred to as “purchase confirmation purchasers”) by applying the additional distribution way and the additional distribution rate of the additional profit, and the profit distribution unit transfers the individual additional profits from an amount kept in the system account unit to the member account units of the purchase confirmation purchasers.

17. The product sales promotion system according to claim 16, further comprising a minimum guaranteed amount calculation unit adapted to notify the terminal of the seller of a minimum guaranteed amount, when the event configuration unit receives the guaranteed amount from the terminal of the seller,
wherein the minimum guaranteed amount is calculated by dividing a largest individual additional profit among the individual additional profits which are calculated when the event is successful by the target amount of product sales.

18. The product sales promotion system according to claim 16, further comprising a minimum guaranteed amount calculation unit adapted to notify the terminal of the seller of a minimum guaranteed amount, when the event configuration unit receives the guaranteed amount from the terminal of the seller,
wherein the minimum guaranteed amount is calculated by dividing the event deposit by the target amount of product sales.

19. The product sales promotion system according to claim 16, wherein the additional distribution way comprises:
arranging the purchase confirmation purchasers in an order of payment;
paying a first individual additional profit calculated by multiplying the additional profit by the additional distribution rate of the additional profit to a first purchase confirmation purchaser who performs an earliest payment among the purchase confirmation purchasers; and
paying a second individual additional profit calculated by multiplying an amount remained after subtracting the first individual additional profit from the additional profit by the additional distribution rate of the additional profit to a second purchase confirmation purchaser who performs a payment in the second earliest among the purchase confirmation purchasers.

20. The product sales promotion system according to claim 16, wherein the member account unit comprises a cyber money account in which cyber money is deposited, and
wherein the additional distribution way comprises:
arranging the purchase confirmation purchasers in an order of a value calculated by multiplying the cyber money amount of the cyber money account of the purchase confirmation purchaser by the number of payments of the purchase confirmation purchasers (hereinafter, referred to as a “multiplied value for order”);
paying a first individual additional profit calculated by multiplying the additional profit by the additional distribution rate of the additional profit to a first purchase confirmation purchaser who has a largest multiplied value for order among the purchase confirmation purchasers; and
paying a second individual additional profit calculated by multiplying an amount remained after subtracting the first individual additional profit from the additional profit by the additional distribution rate of the additional profit to a second purchase confirmation purchaser who has a second largest multiplied value for order among the purchase confirmation purchasers.
